(19) United States
(12) Patent Application Publication
(10) Pub. No.: US 2026/0194875 A1
(43) Pub. Date: Jul. 9, 2026

(54) SYSTEM AND METHOD FOR CONTINUOUS MONITORING OF AN ENTITY

(71) Applicant: SAMSUNG ELECTRONICS CO., LTD., Suwon-si (KR)

(72) Inventors: Ankit JAIN, Bangalore (IN); Mridul GUPTA, Bangalore (IN); Siba Prasad SAMAL, Bangalore (IN); Raveendra KARU, Bangalore (IN); Tarun BANSAL, Bangalore (IN); Krishnendu MAJI, Bangalore (IN); Shubham SWETANK, Bangalore (IN); Sayan GHOSH, Bangalore (IN); Lokesh MEENA, Bangalore (IN)

(73) Assignee: SAMSUNG ELECTRONICS CO., LTD., Suwon-si (KR)

(21) Appl. No.: 19/551,189

(22) Filed: Feb. 26, 2026

Related U.S. Application Data
(63) Continuation of application No. PCT/KR2024/017939, filed on Nov. 14, 2024.

(30) Foreign Application Priority Data
Nov. 21, 2023 (IN) 202341079117

(51) Int. Cl. G05B 15/02; G16Y 20/20; G16Y 40/10

(52) U.S. Cl. CPC G05B 15/02; G16Y 20/20; G16Y 40/10

(57) ABSTRACT

A system and a method for continuous monitoring of an entity in an Internet of Things (IoT) environment are provided. The method includes monitoring, using a first sensor among a plurality of sensors at a first location within the IoT environment, a plurality of behaviors associated with the entity at the first location; identifying a second location within the IoT environment and outside a detection range of the first sensor, wherein the second location is associated with a presence of the entity; identifying, based on pre-stored information associated with the IoT environment, a second sensor from the plurality of sensors for monitoring a subset of the plurality of behaviors associated with the entity at the second location; and monitoring, using the second sensor at the second location, the subset of the plurality of behaviors associated with the entity based on one or more trained models.

### CROSS-REFERENCES TO RELATED APPLICATIONS

This application is a continuation of International Application No. PCT/KR2024/017939, filed on Nov. 14, 2024, which is based on and claims priority to Indian Patent Application No. 202341079117, filed on Nov. 21, 2023, in the Indian Intellectual Property Office, the disclosures of which are incorporated by reference herein in their entireties.

### BACKGROUND

### 1. Field

The disclosure relates to monitoring systems. In particular, the disclosure relates to monitoring of an entity via a plurality of sensors in an Internet of Things (IoT) environment comprising a plurality of edge devices.

### 2. Description of Related Art

In smart home surveillance systems, the monitoring of homes involves the installation of IoT cameras and sensors in various locations such as the front door, living rooms, kitchen, and other areas. Each of these cameras and sensors has a specific field of view (e.g., 120 degrees, 180 degrees, etc.) and range based on their respective capabilities. Home monitoring solutions in the related art primarily rely on single sensors or sensor bundles offered by a single vendor.

In situations where an entity moves out of the range of a particular sensor, the monitoring or prediction process is halted. Consequently, if a similar sensor or capability is not present in other areas, the monitoring discontinues when an entity crosses the range of the particular sensor, which is undesirable.

FIG. 1 is an example scenario of discontinued monitoring of an entity moving around in a house. As depicted, the house might have multiple camera sensors placed at various locations, like the living room 101 and kitchen 105. These cameras have a limited range of monitoring, represented by designated areas 107 and 109. As a result, if an entity, such as an infant or a baby, moves beyond the range of the camera sensor in the living room 101, the monitoring of the baby would halt. Furthermore, in a situation where the baby moves to a bedroom 103 where no camera sensor is installed, there is no means to monitor the baby in that particular room.

In another situation, consider a scenario where bedroom of the elderly parents is equipped with fall detection sensors to enhance their safety. However, due to budget constraints, no sensors are installed in the kitchen. The elderly individuals may face several potential difficulties due to poor visibility, especially during nighttime, such as risk of falling or accidentally breaking sharp objects. Unfortunately, due to the absence of fall sensors in the kitchen, users (such as a caretaker or a guardian) are unable to take any immediate action or receive alerts regarding any issues or accidents that may have occurred.

In yet another scenario, consider a situation where a pet is left alone in a room of a house (say, a bedroom), and its activities are being monitored by a remote video camera (RVC). The camera sends updates to the user regarding the pet's behavior. However, when the pet moves out of sight of the RVC and enters into another room (say, the living room), the user may not receive any update and would have no knowledge of its current activities.

Accordingly, there lies a need to provide a solution to the above-described limitations.

### SUMMARY

In an embodiment, disclosure is provided for a method for monitoring of an entity in an internet of things (IoT) environment. The method includes monitoring, using a first sensor among a plurality of sensors at a first location within the IoT environment, a plurality of behaviors associated with the entity at the first location; identifying a second location within the IoT environment, wherein the second location is associated with a presence of the entity and the second location is outside a detection range of the first sensor; identifying, based on pre-stored information associated with the IoT environment, a second sensor from the plurality of sensors for monitoring a subset of the plurality of behaviors associated with the entity at the second location; and monitoring, using the second sensor at the second location, the subset of the plurality of behaviors associated with the entity based on one or more trained models.

In an embodiment, disclosure is provided for a system for monitoring of an entity in an internet of things (IoT) environment. The system includes a plurality of sensors; at least one processor including processing circuitry; and memory storing instructions that, when executed by the at least one processor individually or collectively, cause the system to monitor, using a first sensor among a plurality of sensors at a first location within the IoT environment, a plurality of behaviors associated with the entity at the first location; identify a second location within the IoT environment, wherein the second location is associated with a presence of the entity and the second location is outside a detection range of the first sensor; identify, based on pre-stored information associated with the IoT environment, a second sensor from the plurality of sensors for monitoring a subset of the plurality of behaviors associated with the entity at the second location; and monitor, using the second sensor at the second location, the subset of the plurality of behaviors associated with the entity based on the one or more trained models.

In an embodiment, disclosure is provided for a non-transitory computer-readable medium storing instructions that, when executed by at least one processor individually or collectively, cause a system to monitor, using a first sensor among a plurality of sensors at a first location within an Internet of Things (IoT) environment, a plurality of behaviors associated with an entity at the first location; identify a second location within the IoT environment, wherein the second location is associated with a presence of the entity and the second location is outside a detection range of the first sensor; identify, based on pre-stored information associated with the IoT environment, a second sensor from the plurality of sensors for monitoring a subset of the plurality of behaviors associated with the entity at the second location; and monitor, using the second sensor at the second location, the subset of the plurality of behaviors associated with the entity based on one or more trained models.

To further clarify the advantages and features of the disclosure, a more particular description of the disclosure will be rendered by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail in the accompanying drawings.

### BRIEF DESCRIPTION OF THE DRAWINGS

The above and other features, aspects, and advantages of certain embodiments of the disclosure will be more apparent from the following detailed description taken in conjunction with the accompanying drawings in which like characters represent like parts throughout the drawings, an in which:

FIG. 1 is an example scenario of monitoring of an entity moving around in a house;

FIG. 2 illustrates a schematic block diagram of an IoT environment in a smart home, according to embodiments of the disclosure;

FIG. 3 is a flow diagram illustrating the controller's continuous monitoring within the smart home, according to embodiments of the disclosure;

FIG. 4 is a schematic diagram illustrating the continuous monitoring system in the smart home, according to embodiments of the disclosure;

FIG. 5 is a block diagram illustrating the plurality of modules of the controller, according to embodiments of the disclosure;

FIG. 6 is a diagram illustrating an example execution of the modules associated with the controller, according to embodiments of the disclosure;

FIGS. 7A, 7B, 7C, and 7D are schematic diagrams illustrating example input and outputs of modules of the continuous monitoring system, according to embodiments of the disclosure; and

FIG. 8 is a block diagram illustrating the method for continuous monitoring of an entity in an IoT environment, according to embodiments of the disclosure.

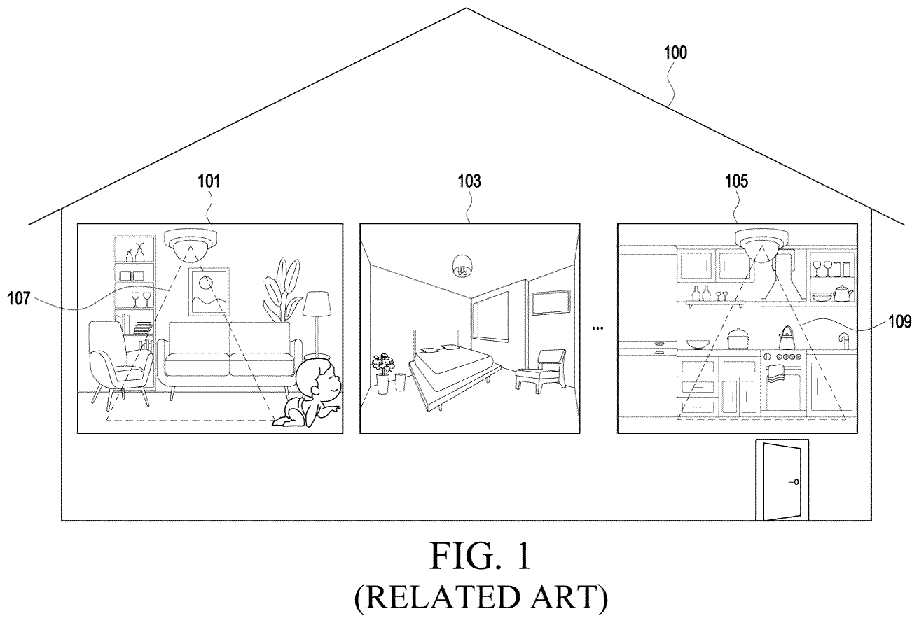

### DETAILED DESCRIPTION

To aid in understanding principles of the disclosure, reference will now be made to the various example embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in another embodiment” and similar language throughout this specification may, but do not necessarily, all refer to the same embodiment.

It is to be understood that as used herein, terms such as, “includes,” “comprises,” “has,” etc. are intended to mean that the one or more features or elements listed are within the element being defined, but the element is not necessarily limited to the listed features and elements, and that additional features and elements may be within the meaning of the element being defined. In contrast, terms such as, “consisting of” are intended to exclude features and elements that have not been listed.

As used herein, expressions such as “at least one of,” when preceding a list of elements, modify the entire list of elements and do not modify the individual elements of the list. For example, the expression, “at least one of A, B, or C,” should be understood as including only A, only B, only C, both A and B, both A and C, both B and C, or all of A, B, and C.

The embodiments herein and the various features and advantageous details thereof are explained more fully with reference to the non-limiting embodiments that are illustrated in the accompanying drawings and detailed in the following description. Descriptions of well-known components and processing techniques are omitted to not unnecessarily obscure the embodiments herein. Also, the various embodiments described herein are not necessarily mutually exclusive, as some embodiments may be combined with one or more other embodiments to form new embodiments. The term “or” as used herein, refers to a non-exclusive or unless otherwise indicated. The examples used herein are intended merely to facilitate an understanding of ways in which the embodiments herein may be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

To solve the above-mentioned problems, the disclosure discloses a mechanism to continuously monitor one or more entities in an IoT environment. The continuous monitoring is performed using a plurality of sensors. The plurality of sensors may have different ranges and capabilities. Further, the plurality of sensors may be provided by the same vendor or different vendors.

Further, according to various embodiments of the disclosure, a system and method is provided for continuous monitoring of an entity by a controller associated with the IoT environment. A plurality of behaviors of a target entity (e.g., a child) are monitored via one or more first sensors (e.g., a camera) present in a first location (e.g., a living room) of the IoT environment. Movement of the target entity from the first location to a second location of the IoT environment is detected, such that the second location is outside or beyond the monitoring range of the first sensors. One or more second sensors present in the second location are identified, and at least a subset of monitored behaviors of the target entity, capable of being monitored by the second sensors, is determined. Finally, one or more trained edge models relevant to the subset of behaviors are invoked for use by the second sensors so as to continue the monitoring of the behavior of the target entity in the second location.

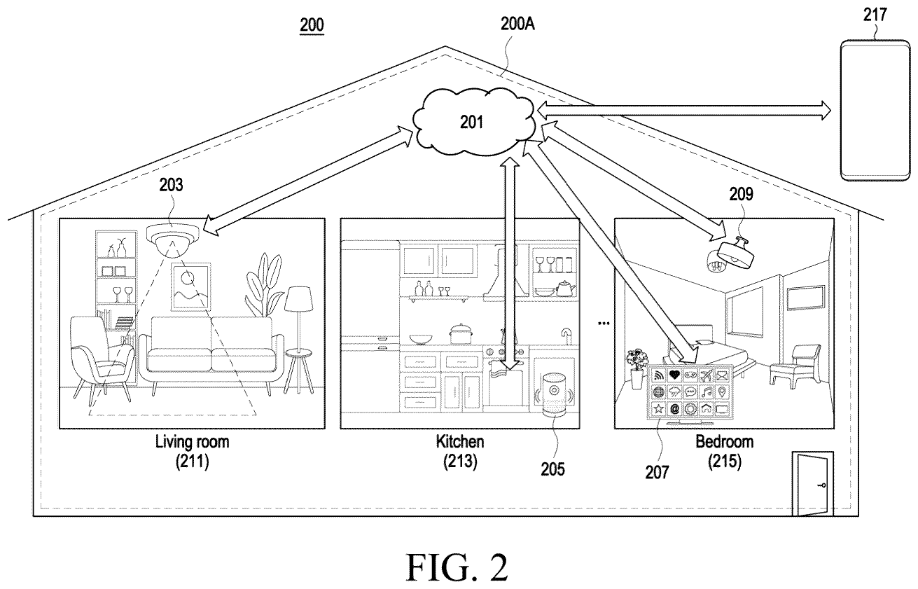

For example, a baby may be monitored using a camera installed in the living room of a house by a user who may be particularly concerned about keeping track of or monitoring the baby's well-being. However, the baby may start crawling, and may move into a different area, such as the kitchen, which falls outside the field of view of the camera in the living room. According to various embodiments of the disclosure, other sensors that are present in the kitchen may be determined. According to various embodiments of the disclosure, one or more trained models that relate to the well-being of a baby like baby crying, baby coughing, glass breaking etc. are determined. Further, the sensors placed in the kitchen that may run such trained models are determined. For example, a smart speaker, and a smart refrigerator may have been installed in the kitchen. According to various embodiments of the disclosure, the relevant trained models are deployed on the smart refrigerator and the smart speaker or a controller, such that the user is alerted in case the baby starts crying, thereby continuing the monitoring of the baby. The techniques provided by the disclosure are now described in detail in conjunction with FIGS. 2 through 8.

FIG. 2 illustrates a schematic block diagram of an IoT environment in a smart home 200, according to an embodiment of the disclosure. The smart home 200 may include a continuous monitoring system 200A. The continuous monitoring system 200A may include a controller 201 communicatively coupled with a plurality of sensors such as camera sensor 203, microphone inside a smart speaker 205, a smart television 207, and a proximity sensor 209. The plurality of sensors may be installed at different locations across various rooms of the smart home 200. For example, the camera sensor 203 may be installed in living room 211, the smart speaker 205 may be installed in the kitchen 213, and the smart television 207 and the proximity sensor 209 may be installed in bedroom 215. It is appreciated that the continuous monitoring system 200A may include additional sensors installed in the same or additional rooms of the smart home 200.

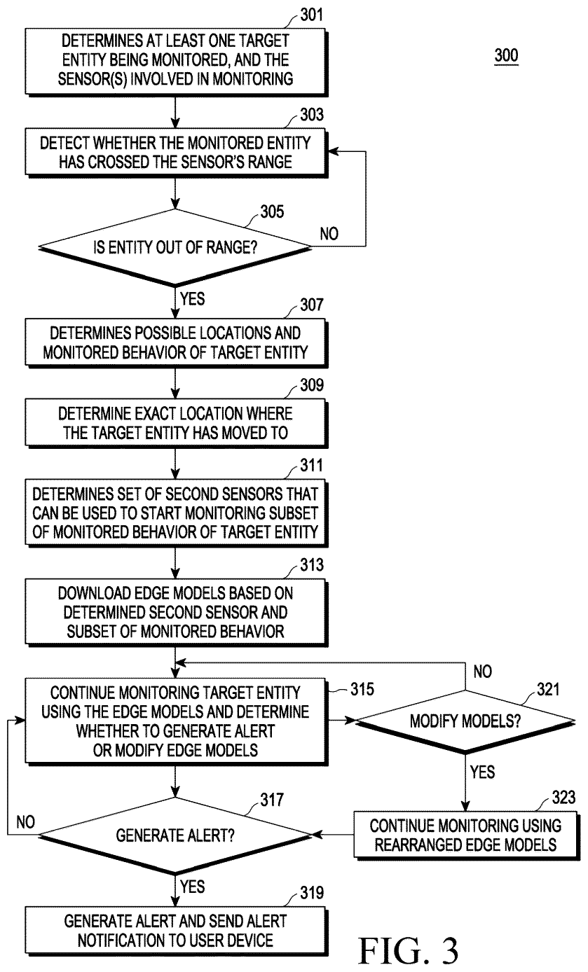

The controller 201 may be configured to monitor the one or more entities within the smart home 200, according to the embodiments of the disclosure, utilizing monitoring data obtained from the plurality of sensors installed across various rooms of the smart home 200. The controller 201 may be communicatively coupled with a user device 217 associated with a user who desires to monitor one or more entities within the smart home 200. In an event of an unexpected incident or undesirable activity, the controller 201 may notify the user by sending alerts on the user device 217. The user device 217 may be any device capable of receiving alerts from the controller 201. The user device 217 may include, but is not limited to, smart phone, laptops and tablets. The controller 201 may perform various operations to achieve the objective of the disclosure, i.e., enabling continuous monitoring throughout the smart home 200. In an embodiment, the controller 201 may be implemented in an individual device within the smart home 200. In another embodiment, the controller 201 may be implemented on a cloud-based server. In another embodiment, the controller 201 may be implemented in a distributed manner such that one or more component of the controller are implemented on the individual device and one or more components are implemented on the cloud-based server. The operations of the controller 201 to achieve the objective of the disclosure are described below in conjunction with FIG. 3.

FIG. 3 is a flow diagram 300 illustrating flow of operations of the controller 201 to enable continuous monitoring within the smart home 200. At operation 301, the controller 201 may determine at least one target entity to be monitored, and a first sensor involved in monitoring the target entity. Hereinafter, the term ‘target entity’ may be used interchangeably with the term ‘monitored entity’. At operation 303, the controller 201 may detect whether the monitored entity has crossed the first sensor's range. At operation 305, the controller 201 may determine whether the entity is out of range. The controller may continue monitoring the entity in case the entity has not crossed the first sensor's range. When the controller 201 detects that the monitored entity has crossed the first sensor's range, the controller 201 may determine one or more possible locations within the smart home 200 where the monitored entity may have gone at operation 307. Further, one or more behaviors associated with the monitored entity may also be determined by the controller 201. At operation 309, the controller 201 is enabled to determine an exact second location from the one or more possible locations where the monitored entity has moved to. At operation 311, the controller 201 is enabled to determine a set of second sensors that may be used to continue monitoring at least a subset of the monitored behavior of the target entity at the second location.

At operation 313, the controller 201 is enabled to invoke one or more edge models on the set of second sensors based on the subset of the monitored behavior. In home monitoring within an IoT environment, the one or more edge models may refer to artificial intelligence (AI)-based models deployed directly on edge devices such as smart speaker, smart refrigerator, smart television and the like, enabling local analysis and real-time decision-making for events such as unexpected incidents or undesirable activities.

At operation 315, using the one or more edge models, the controller 201 may enable continued monitoring the target entity using the set of second sensors, and at operation 317, the controller 201 may determine whether to generate alert or modify edge models. When an unexpected incident or undesirable activity is detected by the set of second sensors, the controller 201 may generate alerts and notify the user by send the alerts on the user device at operation 319. In case when no unexpected incident or undesirable activity occur, no alert is generated.

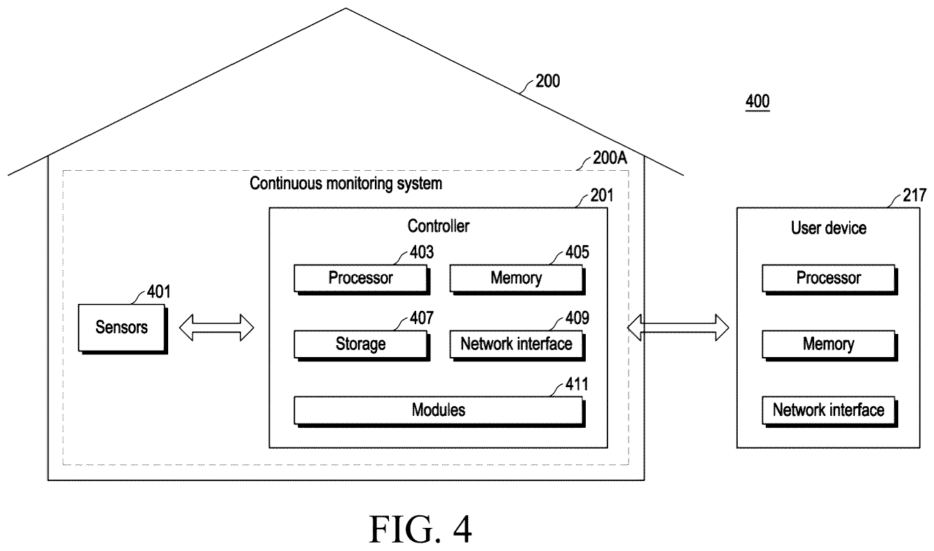

In an embodiment, the controller may also determine to modify the deployed edge models in the set of second sensors, e.g., at operation 321. The edge models may be required to be modified when a different entity enters the second location, or when one of devices associated with the set of second sensors stops working. At operation 323, the controller 201 may continue to monitor the target entity, and the different entity at the second location via the modified edge models on the set of second sensors. The continuous monitoring system 200A including the plurality of sensors and the controller, is now described in detail in conjunction with FIG. 4.

FIG. 4 is a schematic diagram 400 illustrating the continuous monitoring system 200A in the smart home 200, according to an embodiment of the disclosure. As depicted, the continuous monitoring system 200A may include a plurality of sensors 401, and the controller 201 to monitor a plurality of behaviors of an entity within the smart home 200. In an embodiment, the monitored entity may include, but is not limited to, a pet, a baby, or elderly persons living in the smart home 200. In an embodiment, the plurality of behaviors of the entity may be determined based on at least one of a monitoring history, at least one parameter associated with movement of the monitored entity, profile information associated with the monitored entity, or a learned routine of the monitored entity. For example, profile information may include but not limited to user profile, family member added, subscriptions bought related to the entity like dog food subscription if user has a dog.

The plurality of sensors 401 may include different types of sensors installed at different locations within the smart home 200. In an embodiment, the plurality of sensors 401 may be present inside one or more edge devices installed in the smart home 200. The one or more edge devices may include, but is not limited to, a smart speaker, smart refrigerator, and smart television. Accordingly, the plurality of sensors 401 may include, but not limited to, camera sensors, microphones, proximity sensors, temperature sensors, noise sensors, and motion sensors. The sensors of FIG. 2 are used as examples in FIG. 4. The plurality of sensors 401 sensors may possess distinct sensing capabilities and varying sensing ranges. In an embodiment, the different locations within the smart home 200 may include different rooms such as, but not limited to, the living room 211, the kitchen 213, and the bedroom 215. According to various embodiments of the disclosure, one or more sensors of the plurality of sensors 401 may be enabled to monitor at least a subset of the plurality of behaviors of the entity.

The controller 201 may include at least one processor 403, a memory 405 (e.g., RAM), storage 407 (e.g., ROM), network interface 409, and a plurality of modules 411. The processor 403 is configured to execute instructions stored in the memory 405 and to perform various operations as described in the embodiments of the disclosure. The processor 403 may include specialized processing units such as integrated system (bus) controllers, memory management control units, floating point units, graphics processing units, digital signal processing units, etc. In one embodiment, the processor 403 may include a central processing unit (CPU), a graphics processing unit (GPU), or both. The processor 403 may be one or more general processors, digital signal processors, application-specific integrated circuits, field-programmable gate arrays, servers, networks, digital circuits, analog circuits, combinations thereof, or other now known or later developed devices for analyzing and processing data. The processor 403 may execute one or more instructions, such as code generated manually (i.e., programmed) to perform one or more operations disclosed herein throughout the disclosure.

The storage 407 may include one or more databases to store one or more data and information that may be required to implement the continuous monitoring system 200A. In an embodiment, the storage 407 may include one or more AI-based trained models that may be deployed on one or more edge devices enabling one or more sensors within the edge devices to monitor at least a subset of the plurality of behaviors of the target entity. The one or more data and information may include a house plan associated with the smart home 200, providing details about the arrangement and positioning of various rooms within the smart home 200, along with information regarding the edge devices installed in various locations across these rooms. In an embodiment, the information and data may include one or more of a layout associated with a plurality of locations in the IoT environment, configuration information associated with each of the plurality of sensors, known locations visited by the monitored entity in the past, and placement information associated with a presence of each of the plurality of sensors at the plurality of locations in IoT environment, wherein the pre-stored information is stored in the storage associated with the IoT environment. The network interface 409 provides network connectivity and enables communication with the user device 217 over a network.

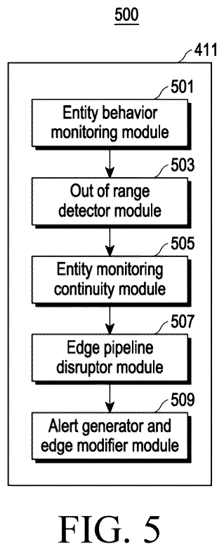

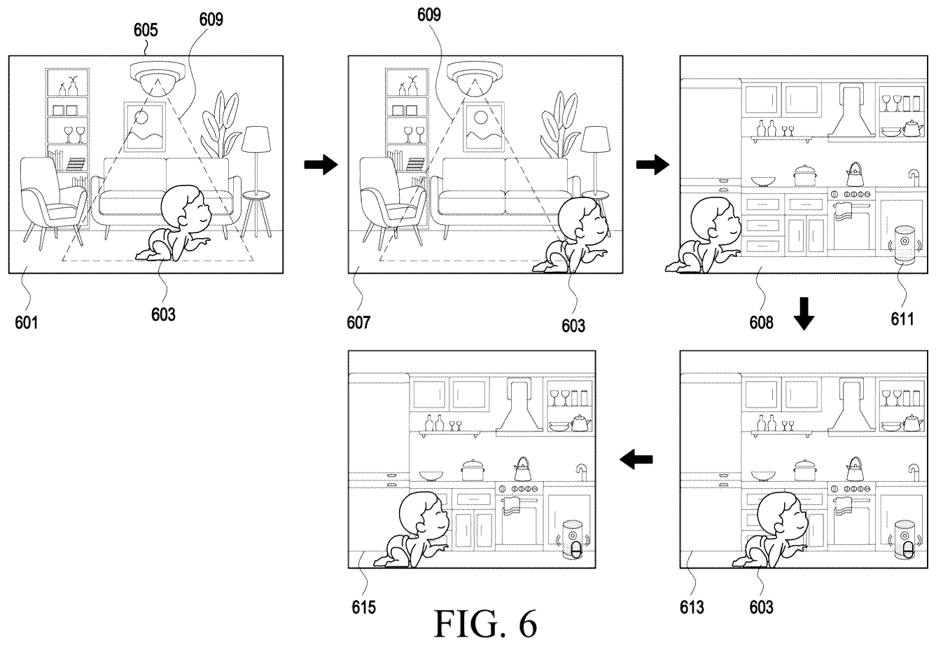

The plurality of modules 411 may include a set of instructions that may be executed to cause the continuous monitoring system 200A to monitor an entity in the IoT environment within the smart home 200, as are described in greater details in conjunction with FIGS. 5 and 6. In an embodiment, the plurality of modules 411 may be hardware units that may be outside the memory 405. At least one of the plurality of modules may be implemented through an AI model. A function associated with AI may be performed through the non-volatile memory, the volatile memory, and the processor 403.

The processor 403 may include one or a plurality of processors. At this time, one or a plurality of processors may be a general purpose processor, such as a central processing unit (CPU), an application processor (AP), or the like, a graphics-only processing unit such as GPU, a visual processing unit (VPU), and/or an AI-dedicated processor such as a neural processing unit (NPU). The one or a plurality of processors control the processing of the input data in accordance with a specified operating rule or artificial intelligence (AI) model stored in the non-volatile memory and the volatile memory. The specified operating rule or artificial intelligence model is provided through training or learning.

Here, being provided through learning means that, by applying a learning technique to a plurality of learning data, a specified operating rule or AI model of a desired characteristic is made. The learning may be performed in a device itself in which AI according to an embodiment is performed, and/o may be implemented through a separate server/system.

The AI model may consist of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning technique is a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, or reinforcement learning.

According to the disclosure, the method for continuous monitoring of an entity in an IoT environment may use an artificial intelligence model to recommend/execute the plurality of instructions by using sensor data. The processor may perform a pre-processing operation on the data to convert into a form appropriate for use as an input for the artificial intelligence model. The artificial intelligence model may be obtained by training. Here, “obtained by training” means that a specified operation rule or artificial intelligence model configured to perform a desired feature (or purpose) is obtained by training a basic artificial intelligence model with multiple pieces of training data by a training technique. The artificial intelligence model may include a plurality of neural network layers. Each of the plurality of neural network layers includes a plurality of weight values and performs neural network computation by computation between a result of computation by a previous layer and the plurality of weight values.

Reasoning prediction is a technique of logically reasoning and predicting by determining information and includes, e.g., knowledge-based reasoning, optimization prediction, preference-based planning, or recommendation. In an embodiment, the user device 217 may also include a processor, memory, and a network interface with characteristics similar to those of the corresponding components in the controller 201. These components are not elaborated upon here to maintain brevity. The plurality of modules 411 are now described below in conjunction with FIGS. 5 and 6.

FIG. 5 is a block diagram 500 illustrating the plurality of modules 411 of the controller 201 within the continuous monitoring system 200A, according to an embodiment of the disclosure. FIG. 6 is a pictorial diagram 600 illustrating an example execution of the plurality of modules 411, according to an embodiment of the disclosure. The plurality of modules 411 may include an entity behavior monitoring module 501, an out of range detector module 503, an entity monitoring continuity module 505, an edge pipeline disruptor module 507, and an alert generator and edge modifier module 509.

The entity behavior monitoring module 501 may be configured to determine the target entity chosen to be monitored within the smart home 200 by the user, monitoring stats corresponding to the information collected during monitoring of the target entity in the current monitoring scenario providing insights into the behavior of the target entity, and a first sensor that is responsible for majority of the monitoring stats being generated. The first sensor may be present at a first location within the smart home 200, and may have a specified range of detection. In an embodiment, the first sensor may include one or more sensors present at the first location. In a case when the target entity moves from the first location to another location within the smart home 200, it may be possible that the target entity goes out of the specified range of detection of the first sensor that was monitoring the target entity. The out of range detector module 503 may be configured to determine that the target entity has moved to some other location, i.e., one or more possible locations outside beyond the specified range of detection of the first sensor such that the one or more possible locations is associated with the presence of the monitored entity. The out of range detector module 503 may be further configured to determine the monitored behavior of the target entity.

Further, the entity monitoring continuity module 505 may be configured to determine a second location where the target entity has moved to, and a second sensor that may be used to monitor a subset of the monitored behavior of the target entity. In an embodiment, the second sensor may include one or more sensors present at the second location. The edge pipeline disruptor module 507 may be configured to invoke edge models based on the capabilities of the second sensor and the subset of the monitored behavior of the target entity. The alert generator and edge modifier module 509 may be configured to determine whether to generate an alert or modify the edge models. When it is determined that an alert should be generated, an alert is generated and sent to the user on the user device. However, when the edge models are to be modified due to entry of a different entity at the second location or one of the second sensor becoming non-functional, the alert generator and edge modifier module 509 may modify the earlier invoked edge models, and enable continuous monitoring at the second location via the modified edge models. Each of the modules 411 will be described below in detail.

The entity behavior monitoring module 501 determines the target entity being monitored and the first sensor monitoring a plurality of behaviors associated with the monitored entity (i.e., the target entity) at a first location within the IoT environment. The first sensor may be from a plurality of sensors associated with the IoT environment and may be present at the first location. The entity behavior monitoring module 501 determines the target entity being monitored from the output of a monitoring service availed by the user and information shared with the user, such that the information corresponds to alerts, notifications, routines, and similar data associated with the target entity.

Further, the entity behavior monitoring module 501 determines the first sensor by determining the sensor which gives maximum outputs associated with the target entity. To determine the sensor which gives maximum outputs associated with the target entity, sensors that give relevant data about the target entity are aggregated. Thereafter, the sensors'percentage focus on the target entity is calculated based on past event occurrences associated with the sensors. Thereafter, one or more sensors with events greater than a predetermined threshold are identified as the first sensor, and capabilities of the first sensor are determined in relation to the target entity. In an embodiment, the predetermined threshold is calculated from total monitoring events and target entity specific total events.

After determining the first sensor, and capabilities of the first sensor in relation to the target entity, the monitoring stats generated by the first sensor is determined by scoring and filtering the top monitored stats associated with the target entity that may useful for the user. For scoring and filtering the top monitored stats, all the available monitoring stats associated with the target entity provided by the monitoring service is collected. Thereafter, each monitoring stats is scored based on parameters such as but not limited to association of the monitoring stats with the first sensor, first sensor's capability, and user interest in the monitoring stats. Thereafter, the monitoring stats with highest score is filtered as definition of the monitoring service. Therefore, the entity behavior monitoring module 501 results in determination of the target entity being monitored, the first sensor monitoring the determined target entity, and the monitoring stats associated with the target entity generated by the first sensor.

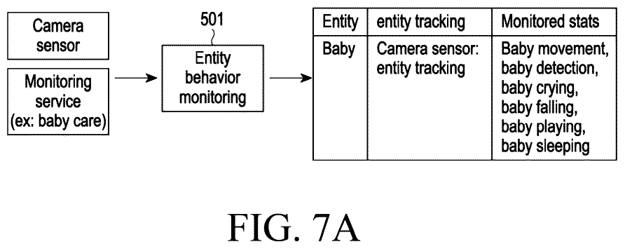

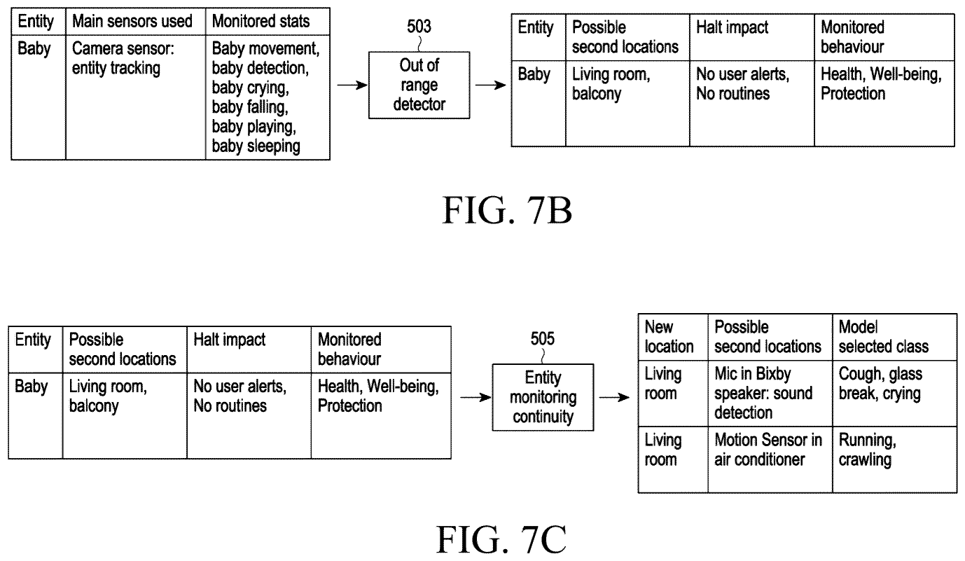

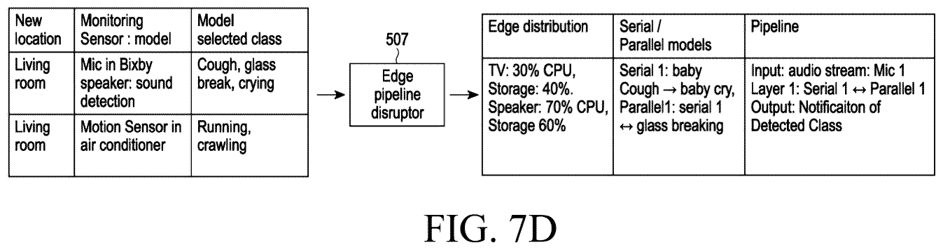

For example, as depicted in FIG. 6 in block 601, the entity behavior monitoring module 501 may determine the baby 603 as the target entity and camera sensor 605 as the first sensor. In the example, the monitoring stats associated with the baby 603 generated by the camera sensor 605 may include, but is not limited to, baby movement, baby detection, baby crying, baby falling, baby playing, and baby sleeping. The example input and output of the entity behavior monitoring module 501 are depicted in FIG. 7A. In an embodiment, the first sensor may determine that the target entity has moved out the sensing range of the first sensor. For example, as depicted in FIG. 6 in block 607, while monitoring the baby movement, the camera sensor 605 may determine that the baby 603 has moved out of the sensing range 609 of the camera sensor 605. At this point, the baby 603 may be left unattended and unmonitored and the user may not be able to receive any alerts associated with the baby 603. Thus, the user may become constantly concerned about health, well-being, and protection of the baby 603.

The out of range detector module 503 determines one or more possible locations where the target entity may be present. The out of range detector module 503 further determines the monitored behavior of the target entity. In an embodiment, the one or more possible locations may be determined by using last tracking data of the monitored entity and last left timestamp to determine the direction of movement of the monitored entity, and correlating with the knowledge of the house plan associated with the smart home including details about the arrangement and positioning of various rooms within the smart home, along with information regarding the edge devices installed in various locations across these room.

In an embodiment, the monitored behavior of the target entity may be determined by sending the monitoring stats generated by the first sensor to a pre-trained model to obtain monitored behavior association scores, and selecting the monitored behavior association scores above a specified threshold to determine general set of monitored behavior of the target entity. In an embodiment, dependent alerts, notification, and routines on first sensor for data for next activity are aggregated and next activity of all the dependents are collected. Thereafter, relevancy of the next activities, and the user's current status is calculated based on monitoring. Further, paused events above a specified threshold are obtained. The paused events correspond to the events that would not happen when the entity monitoring is halted. For example, providing continuous notification on the monitored entity's activities.

Therefore, the out of range detector module 503 results in determination of the one or more possible locations of the target entity, general set of monitored behavior of the target entity, and paused events. For example, when the baby 603 moves out of sensing range 609 of the camera sensor 605, the out of range detector module 503 may determine kitchen, or balcony, as the one or more possible locations, health, well-being, and protection as the general set of monitored behavior of the target entity, and no user alerts and routine as paused events. The example input and output of the out of range detector module 503 are depicted in FIG. 7B.

The entity monitoring continuity module 505 determines the second location from the one or more possible location where the target entity has moved to, and the second sensor that may be used to monitor a subset of the monitored behavior of the target entity. The entity monitoring continuity module 505 determines one or more sensors present at the one or more possible locations, and identify the second location from the one or more possible locations based on monitoring of a physical environment by the determined one or more sensors. In an embodiment, the monitoring of the physical environment includes detecting, by at least one of the one or more sensors present at a corresponding possible location of the one or more possible locations, a change in the physical environment around the at least one of the one or more sensors.

The change in the physical environment may be associated with the presence of the monitored entity at the corresponding possible location, and may correspond to a change in smell, odor, sound, light, temperature, humidity, movement or any other change around the at least one of the one or more sensors that may trigger automated actions or alerts. Upon detecting the change in the physical environment, the entity monitoring continuity module 505 may be configured to identify the possible location corresponding to the at least one of the one or more sensors as the second location. Furthermore, the entity monitoring continuity module 505 is configured to determine the second sensor that may be used to monitor a subset of the monitoring behavior of the target entity. In an embodiment, the second sensor may include one or more sensors that may be present at the second location.

To determine the second location, the entity monitoring continuity module 505 may be configured to determine one or more sensors that may be present at the one or more possible locations obtained from the out of range detector module 503. Thereafter, the entity monitoring continuity module 505 identifies data values from sensor information, associated with the one or more sensors, that may indicate the presence of a new entity. In an embodiment, past sensor data may be used to cut the background noise so any new signals may be inferred to as entity presence with suitable thresholds. Location of the sensors that indicated presence of new entity, may be identified as the second location. Further, the entity monitoring continuity module 505 may determine the second sensor, and capabilities of the second sensor that may be present at the second location. For example, the second sensor may include microphone in smart speaker edge device having sound sensing capabilities, and an inertial unit in a tablet having vibration sensing capabilities.

Further, the entity monitoring continuity module 505 may retrieve relevant edge models that may be executed based on the capabilities of the second sensor. In an embodiment, a database stored in the storage 407 may be utilized to obtain a list of accessible edge model categories and the corresponding sensor data required for the edge models to make inferences. For example, for microphone, a sound detection model having classes such as but not limited to dog barking, baby crying and falling may be used as relevant edge model.

Further, the entity monitoring continuity module 505 may associate the model inferences to the monitored behavior to determine the most associative model inferences. In an embodiment, the list of classes relevant to the capabilities of the sensors present in the second location is obtained, and passed through a predetermined neural network based model type to determine the score of monitored behaviors. Thereafter, a top scored classification of the monitored behavior may be chosen based on a specified threshold and mapped with a superset of monitored behaviors to filter out the relevant model classes. Finally, most associated model inferences for the corresponding sensor are selected. Therefore, the entity monitoring continuity module 505 may result in determination of the second location, the second sensor at the second location, and model inferences associated with the second sensor. For example, living room may determines as the second location, microphone sensor and motion sensor in edge devices such as smart speaker and a smart air conditioner present in the living room may be determined as the second sensor. Further, sound detection model, and corresponding class such as cough, glass break, and crying may be determined. Similarly, motion detection model, and corresponding class such as running and crawling may be determined. In an example, as depicted in FIG. 6 in block 608, kitchen may be determined as the second location, and microphone in smart speaker 611 present in the kitchen may be determined as second sensor. The example input and output of the entity monitoring continuity module 505 is depicted in FIG. 7C.

The edge pipeline disruptor module 507 invokes edge models based on the capabilities of the second sensor and the subset of the monitored behavior of the target entity. In an embodiment, the availability of edge devices at the second location is obtained. A pipeline of edge models is created with input and output, as well as serialized and parallel models. The edge devices that may run particular models are being determined. Based on the availability of the edge devices, relevant edge models are invoked and loaded onto the corresponding edge devices. The pipeline is started by inferring using sensor data as input.

In an embodiment the edge pipeline disruptor module 507 takes as input the second location, the second sensor at the second location, and model inferences associated with the second sensor determined by the entity monitoring continuity module 505. According to the embodiments of the disclosure, the edge pipeline disruptor module 507 results in determination of edge distribution corresponding to second sensor present at the second location, serial or parallel models for creating the pipeline as depicted in FIG. 7D. In an example, as depicted in FIG. 6 in block 613, relevant edge model may be loaded onto the microphone in the smart speaker 611 or a smart refrigerator and may be utilized to continue monitoring the target entity, i.e., the baby 603.

The alert generator and edge modifier module 509 generates an alert in an event when an unexpected activity is monitored by the second sensor. In an embodiment, the alert is sent to the user on the user device. In an embodiment, the alert generator and edge modifier module 509 also determines a requirement to modify the edge models based either on entry of a different entity at the second location, or an edge device at the second location becoming non-functional. In either case, the edge models may be modified by addition of models based on the behavior of the different entity or removal of edge model corresponding to the non-functional edge device. The monitoring may continue via the modified edge models. In an example, as depicted in FIG. 6 in block 615, an event of baby crying may be identified, and the user may be provided with an alert associated with the event.

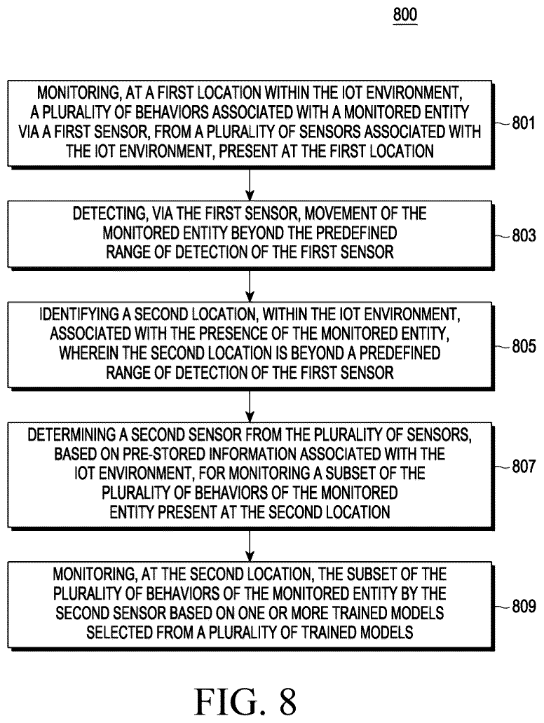

FIG. 8 is a block diagram illustrating the method 800 for continuous monitoring of an entity in an IoT environment, according to an embodiment of the disclosure. The method 800 includes, at operation 801, monitoring, at a first location within the IoT environment, a plurality of behaviors associated with a monitored entity via a first sensor, from a plurality of sensors associated with the IoT environment, present at the first location. In an embodiment, the plurality of behaviors associated with the monitored entity is determined based on at least one of a monitoring history, at least one parameter associated with movement of the monitored entity, profile information associated with the monitored entity, or a learned routine of the monitored entity.

Thereafter, the method 800 includes, at operation 803, detecting, via the first sensor, movement of the monitored entity outside or beyond the specified range of detection of the first sensor. Thereafter, the method 800 includes, at operation 805, identifying a second location, within the IoT environment, associated with the presence of the monitored entity, wherein the second location is outside or beyond a specified range of detection of the first sensor. In an embodiment, identifying the second location includes determining one or more possible locations outside or beyond the specified range of detection of the first sensor, wherein the one or more possible locations are associated with the presence of the monitored entity. Thereafter, the method includes determining one or more sensors present at the one or more possible locations, and identifying the second location from the one or more possible locations based on monitoring of a physical environment by the determined one or more sensors.

In an embodiment, identifying the second location from the one or more possible locations based on monitoring of a physical environment by the determined one or more sensors includes detecting, by at least one of the one or more sensors present at a corresponding possible location of the one or more possible locations, a change in a physical environment around the at least one of the one or more sensors, wherein the change in the physical environment is associated with the presence of the monitored entity at the corresponding possible location. Thereafter, the method includes identifying, upon detecting the change in the physical environment around the at least one of the one or more sensors, the corresponding possible location as the second location.

In an embodiment, identifying the second sensor from the plurality of sensors is based on an association of one or more sensing capabilities of the second sensor with the subset of the plurality of behaviors of the monitored entity. In an embodiment, the one or more possible locations are determined based on at least one parameter associated with a movement of the monitored entity tracked by the first sensor or monitored by the first sensor and the pre-stored information associated with the IoT environment.

Thereafter, the method 800 includes, at operation 807, determining a second sensor from the plurality of sensors, based on pre-stored information associated with the IoT environment, for monitoring a subset of the plurality of behaviors of the monitored entity present at the second location. In an embodiment, the pre-stored information associated with the IoT environment may includes one or more of a layout associated with a plurality of locations in the IoT environment, configuration information associated with each of the plurality of sensors, known locations visited by the monitored entity in the past, and placement information associated with a presence of each of the plurality of sensors at the plurality of locations in IoT environment, wherein the pre-stored information is stored in a memory associated with the IoT environment.

Thereafter, the method 800 includes, at operation 809, monitoring, at the second location, the subset of the plurality of behaviors of the monitored entity by the second sensor based on one or more trained models selected from a plurality of trained models. In an embodiment, for monitoring, the method may include selecting the one or more trained models from the plurality of trained models based on association of the subset of the plurality of behaviors of the monitored entity with one or more capabilities of the second sensor.

At least by virtue of aforesaid, the subject matter at least provides the following advantages:

The method described in the embodiments provides continuous monitoring to the user even when a sensor reaches its range limit by using edge distributed AI-based models and other sensors available in other locations by understanding and determining the monitoring characteristics the user is interested in. Further, method described in the embodiments enables monitoring to never be stopped unless intended. This reduces tension to users and gives them relief that every device is monitoring the exact thing that they want monitored. Further, the method described in the embodiments makes sure all smart devices in a user's home environment are utilized to maximum by not just working them when user wants explicitly but also when the situation needs inputs/data or processing from these devices. Furthermore, the method described in the embodiments helps users to reduce their monitoring cost as users don't have to buy redundant sensors for their smart home environment and don't have to worry even when they have less sensors in corner situation. Finally, the method described in the embodiments enables the edge computing to not run the model always on the edge environment occupying data and compute. The disclosure makes it need based and hence is able to dial down the models to only those which are needed in the current scenario helping avoid edge bottlenecks.

While specific language has been used to describe the subject matter, any limitations arising on account thereto, are not intended. As would be apparent to a person in the art, various working modifications may be made to the method in order to implement the disclosure presented herein. Although example embodiments have shown in the drawings and described, embodiments of the disclosure are not limited thereto. Those skilled in the art will appreciate that one or more of the described elements may well be combined into a single functional element. Alternatively, certain elements may be split into multiple functional elements. Elements from one embodiment may be added to another embodiment.

What is claimed is:

1. A method for monitoring of an entity in an Internet of Things (IoT) environment, the method comprising:
monitoring, using a first sensor among a plurality of sensors at a first location within the IoT environment, a plurality of behaviors associated with the entity at the first location;
identifying a second location within the IoT environment, wherein the second location is associated with a presence of the entity and the second location is outside a detection range of the first sensor;
identifying, based on pre-stored information associated with the IoT environment, a second sensor from the plurality of sensors for monitoring a subset of the plurality of behaviors associated with the entity at the second location; and
monitoring, using the second sensor at the second location, the subset of the plurality of behaviors associated with the entity based on one or more trained models.

2. The method of claim 1, further comprising:
selecting the one or more trained models from a plurality of trained models based on association between the subset of the plurality of behaviors associated with the entity and one or more capabilities of the second sensor.

3. The method of claim 1, wherein the identifying the second location comprises:
identifying one or more locations outside the detection range of the first sensor, wherein the one or more locations are associated with the presence of the entity;
identifying one or more sensors at the one or more locations; and
identifying the second location from the one or more locations based on monitoring of a physical environment by the one or more sensors.

4. The method of claim 3, wherein the identifying the second location from the one or more locations based on monitoring of the physical environment by the one or more sensors comprises:
detecting, by at least one of the one or more sensors at a corresponding location of the one or more locations, a change in the physical environment around the at least one of the one or more sensors, wherein the change in the physical environment is associated with the presence of the entity at the corresponding location; and
based on the detecting the change in the physical environment around the at least one of the one or more sensors, identifying the corresponding location as the second location.

5. The method of claim 2, wherein the identifying the second sensor comprises identifying the second sensor based on an association between one or more sensing capabilities of the second sensor and the subset of the plurality of behaviors of the entity.

6. The method of claim 3, wherein the identifying the one or more locations comprises identifying the one or more locations based on at least one parameter associated with a movement of the entity monitored by the first sensor and based on the pre-stored information associated with the IoT environment.

7. The method of claim 1, wherein the pre-stored information associated with the IoT environment comprises at least one of:
a layout associated with a plurality of locations in the IoT environment,
configuration information associated with each of the plurality of sensors,
locations visited by the entity, or placement information associated with a respective presence of each of the plurality of sensors at the plurality of locations in the IoT environment, and
wherein the pre-stored information is stored in a memory associated with the IoT environment.

8. The method of claim 1, wherein prior to the identifying the second location, the method further comprises detecting, using the first sensor, movement of the entity outside the detection range of the first sensor.

9. The method of claim 1, wherein the plurality of behaviors associated with the entity are based on at least one of a monitoring history, at least one parameter associated with movement of the entity, profile information associated with the entity, or a learned routine of the entity.

10. A system for monitoring of an entity in an Internet of Things (IoT) environment, the system comprises:
a plurality of sensors;
at least one processor including processing circuitry;
memory storing instructions,
wherein the instructions, when executed by the at least one processor individually or collectively, cause the system to:
monitor, using a first sensor among a plurality of sensors at a first location within the IoT environment, a plurality of behaviors associated with the entity at the first location;
identify a second location within the IoT environment, wherein the second location is associated with a presence of the entity and the second location is outside a detection range of the first sensor;
identify, based on pre-stored information associated with the IoT environment, a second sensor from the plurality of sensors for monitoring a subset of the plurality of behaviors associated with the entity at the second location; and
monitor, using the second sensor at the second location, the subset of the plurality of behaviors associated with the entity based on the one or more trained models.

11. The system of claim 10, wherein the instructions, when executed by the at least one processor individually or collectively, further cause the system to:
select the one or more trained models from a plurality of trained models based on association between the subset of the plurality of behaviors associated with the entity and one or more capabilities of the second sensor, and
wherein the second sensor is identified based on an association between one or more sensing capabilities of the second sensor and the subset of the plurality of behaviors of the entity.

12. The system of claim 10, wherein the instructions, when executed by the at least one processor individually or collectively, further cause the system to:
identify one or more locations outside the specified range of detection of the first sensor, wherein the one or more possible locations are associated with the presence of the monitored entity;
identify one or more sensors present at the one or more possible locations; and
identify the second location from the one or more possible locations based on monitoring of a physical environment by the one or more sensors.

13. The system of claim 12, wherein the one or more locations are based on at least one parameter associated with a movement of the entity monitored by the first sensor and based on the pre-stored information associated with the IoT environment,
wherein the pre-stored information associated with the IoT environment comprises at least one of:
a layout associated with a plurality of locations in the IoT environment,
configuration information associated with each of the plurality of sensors, locations visited by the entity, or placement information associated with a respective presence of each of the plurality of sensors at the plurality of locations in the IoT environment, and
wherein the pre-stored information is stored in the storage associated with the IoT environment.

14. The system of claim 10, wherein the instructions, when executed by the at least one processor individually or collectively, further cause the system to, prior to identifying the second location, detect, using the first sensor, movement of the entity outside the detection range of the first sensor.

15. The system of claim 10, wherein the plurality of behaviors associated with the entity are based on at least one of a monitoring history, at least one parameter associated with movement of the entity, profile information associated with the entity, or a learned routine of the entity.

16. A non-transitory computer-readable medium storing instructions that, when executed by at least one processor individually or collectively, cause a system to:
monitor, using a first sensor among a plurality of sensors at a first location within an Internet of Things (IoT) environment, a plurality of behaviors associated with an entity at the first location;
identify a second location within the IoT environment, wherein the second location is associated with a presence of the entity and the second location is outside a detection range of the first sensor;
identify, based on pre-stored information associated with the IoT environment, a second sensor from the plurality of sensors for monitoring a subset of the plurality of behaviors associated with the entity at the second location; and
monitor, using the second sensor at the second location, the subset of the plurality of behaviors associated with the entity based on one or more trained models.

17. The non-transitory computer-readable medium of claim 16, wherein the one or more instructions, when executed by at least one processor individually or collectively, further cause the system to:
select the one or more trained models from a plurality of trained models based on association between the subset of the plurality of behaviors associated with the entity and one or more capabilities of the second sensor,
wherein the second sensor is identified based on an association between one or more sensing capabilities of the second sensor and the subset of the plurality of behaviors of the entity.

18. The non-transitory computer-readable medium of claim 16, wherein for identifying the second location, the one or more instructions, when executed by at least one processor individually or collectively, further cause the system to:
identify one or more locations outside the specified range of detection of the first sensor, wherein the one or more possible locations are associated with the presence of the monitored entity;
identify one or more sensors present at the one or more possible locations; and
identify the second location from the one or more possible locations based on monitoring of a physical environment by the one or more sensors.

19. The non-transitory computer-readable medium of claim 18, wherein the one or more locations are based on at least one parameter associated with a movement of the entity monitored by the first sensor and based on the pre-stored information associated with the IoT environment,
wherein the pre-stored information associated with the IoT environment comprises at least one of:
a layout associated with a plurality of locations in the IoT environment,
configuration information associated with each of the plurality of sensors, locations visited by the entity, or placement information associated with a respective presence of each of the plurality of sensors at the plurality of locations in the IoT environment, and
wherein the pre-stored information is stored in the storage associated with the IoT environment.

20. The non-transitory computer-readable medium of claim 16, wherein the one or more instructions, when executed by at least one processor individually or collectively, further cause the system to prior to identifying the second location, detect, using the first sensor, movement of the entity outside the detection range of the first sensor, and
wherein the plurality of behaviors associated with the entity are based on at least one of a monitoring history, at least one parameter associated with movement of the entity, profile information associated with the entity, or a learned routine of the entity.
